(19) United States
(12) Patent Application Publication
(10) Pub. No.: US 2012/0002570 A1
(43) Pub. Date: Jan. 5, 2012

(54) Coordinating and Establishing Communication Networks Between Communication Devices

(75) Inventors: Makoto NISHIDA, Nagoya-shi (JP); Yasuhiro KUDO, Ichinomiya-shi (JP)

(73) Assignee: BROTHER KOGYO KABUSHIKI KAISHA, Nagoya-shi (JP)

(21) Appl. No.: 13/173,064

(22) Filed: Jun. 30, 2011

(30) Foreign Application Priority Data
Jun. 30, 2010 (JP) 2010-149560

(51) Int. Cl. H04L 12/28

(52) U.S. Cl. 370/254

(57) ABSTRACT

In a multipoint mesh network, communications for establishing the network between multiple communication terminals may be coordinated such that connection request signals are not transmitted from both terminals in a pair of terminals to each other. In one example, a multipoint connection start terminal may be configured to request connections with each of the communication terminals participating in the mesh network. The multipoint connection start terminal may then receive a connection permission signal from each of the terminals to which a request signal was sent. The multipoint connection start terminal may subsequently generate terminal designation information specifying which terminals are to request connections with which other terminals so as to avoid communication overlap. This terminal designation information may then be transmitted to each of the other communication terminals participating in the mesh network. Additionally or alternatively, the terminal designation information may include authentication information for authenticating the connection request and/or permissions.

### CROSS-REFERENCE TO RELATED APPLICATION

Nail This application claims priority to Japanese Patent Application No. 2010-149560, filed on Jun. 30, 2010, the content of which is hereby incorporated by reference in its entirety.

### TECHNICAL FIELD

The disclosure relates to communication terminals at three or more locations which connect to each other to transmit and receive data, a communication method, and a computer-readable medium having stored therein a communication program.

### BACKGROUND

In the existing art, full mesh connections between multipoint connection terminal devices at three or more locations have been proposed. A full mesh connection generally includes a connection mode which allows and provides direct communication with all other partners belonging to the same network. For example, in a full mesh arrangement, each device may transmit a list of identification information of all connection candidate terminals to all terminals connected to the device. Using the list of identification information, each terminal receiving the list transmits a connection request to terminals which have not been connected to the terminal. By repeating this process until all terminals achieve full mesh connections, a multipoint full mesh connection is achieved.

### SUMMARY

Communication terminals for which a mesh connection is to be established may include communication terminals at three or more locations and may include a communication terminal designated as a multipoint connection start terminal. Each of the communication terminals may be designated as a transmission source terminal or a transmission destination terminal with respect to each of the other communication terminals. Additionally, each communication terminal may include a transmitter, a receiver and/or a transceiver configured to communicate with each of the other communication terminals.

When acting as the multipoint connection start terminal, a communication terminal may be configured to transmit a signal requesting a connection to each connection destination terminal. Connection destination terminals may include, for example, the other communication terminals not acting as the multipoint connection start terminal. In response to the connection request signal, the multipoint connection start terminal may receive a connection permission signal from each of the connection destination terminals to which a connection request signal was transmitted. Upon receipt of the connection permission signal, the multipoint connection start terminal may generate terminal designation information for and specific to each of the connection destination terminals based on a reception order of the connection permission signals. The terminal designation information may include destination terminal information specifying the communication terminal(s) that the connection destination terminal is to transmit a connection request signal. The terminal designation information may further designate transmission source terminal information specifying other connection destination terminals from which a connection request signal is to be received by the connection destination terminal. The multipoint connection start terminal may further be configured to transmit the generated terminal designation information to the connection destination terminals.

According to another aspect, each of the communication terminals not acting as the multipoint connection start terminal may be configured to receive a connection request signal transmitted by the multipoint connection start terminal and to transmit a connection permission signal permitting a connection to the multipoint connection start terminal upon receipt of the connection request signal. After transmitting the connection permission signal, each non-multipoint connection start terminal may receive terminal designation information from the multipoint connection start terminal. Based upon the terminal designation information, each terminal may then transmit connection request signals or to await receipt of connection request signals with respect to each of the other connection destination terminals. If a terminal is designated to transmit a connection request signal to another terminal, the transmitting terminal may further be configured to await a connection permission signal from the other terminal in response to the request. Alternatively or additionally, if the terminal is designated to receive a connection request signal from the other terminal, the terminal may be configured to respond to the connection request signal with a connection permission signal.

According to another aspect, a method for establishing a full mesh connection may include, for example: transmitting, by a multipoint connection start terminal, a connection request signal requesting a connection to each of one or more connection destination terminals such as two or more other communication terminals; receiving, by the multipoint connection start terminal, a connection permission signal from each of the one or more connection destination terminals; optionally determining whether connection permission signals have been received from each of the connection destination terminals; generating terminal designation lists for each of the connection destination terminals from which a connection permission signal has been received; and transmitting the terminal designation list to a corresponding connection destination terminal. In some arrangements, terminal designation lists might not be created until connection permission signals have been received from all connection destination terminals to which a request signal was sent. In other arrangements, terminal designation lists may be created on-the-fly, e.g., upon receipt of a connection permission signal.

According to another aspect, a communication terminal acting as a connection destination terminal (e.g., a non-multipoint connection start terminal) may perform a method comprising: receiving a connection request signal from the multipoint connection start terminal; in response to the receiving the connection request signal, transmitting a connection permission signal to the multipoint connection start terminal; receiving terminal designation information from the multipoint connection start terminal; transmitting a connection request signal to each communication terminal specified as a transmission destination terminal in the terminal designation information; receiving a connection permission signal from each of the transmission destination terminals to which a connection request signal is transmitted; receiving a connection request signal from each of one or more transmission source terminals specified in the terminal designation information; and transmitting a connection permission signal to each of the one or more transmission source terminals.

According to another aspect, the processes and functions described herein (e.g., the methods described above) may be stored as computer readable instructions on one or more non-transitory computer readable media. The computer readable instructions, when executed, may cause an apparatus such as a communication device or apparatus having one or more processors to perform corresponding processes and functions (e.g., operating as a multipoint connection start terminal and/or a connection destination terminal).

### BRIEF DESCRIPTION OF THE DRAWINGS

FIG. 1 is a block diagram showing an example configuration of a communication system according to one or more aspects described herein;

FIG. 2 is a block diagram showing an example electrical configuration of a communication terminal according to one or more aspects described herein;

FIG. 3 is a schematic diagram showing an example connected terminal list according to one or more aspects described herein;

FIG. 4 is a schematic diagram showing an example terminal designation list according to one or more aspects described herein;

FIG. 5 is a schematic diagram showing an example terminal designation list according to one or more aspects described herein;

FIG. 6 is a schematic diagram showing an example terminal designation list according to one or more aspects described herein;

FIG. 7 is a diagram showing an example communication process of a communication system according to one or more aspects described herein;

FIG. 8 is a flowchart showing an example multipoint connection process according to one or more aspects described herein;

FIG. 9 is a flowchart showing an example multipoint connection start process according to one or more aspects described herein;

FIG. 10 is a flowchart showing an example connection request reception process according to one or more aspects described herein;

FIG. 11 is a schematic diagram showing an authentication key allocation list according to one or more aspects described herein;

FIG. 12 is a schematic diagram showing an example terminal designation list according to one or more aspects described herein;

FIG. 13 is a schematic diagram showing an example terminal designation list according to one or more aspects described herein;

FIG. 14 is a schematic diagram showing an example terminal designation list according to one or more aspects described herein;

FIG. 15 is a flowchart showing another example multipoint connection start process according to according to one or more aspects described herein;

FIG. 16 is a flowchart showing another example connection request reception process according to one or more aspects described herein; and

FIG. 17 is a flowchart showing yet another example multipoint connection start process according to one or more aspects described herein.

### DETAILED DESCRIPTION

Hereinafter, a communication system 1 including communication terminals 3 to 6 which are one embodiment embodying communication terminals of the disclosure, will be described with reference to the drawings. Note that the referenced drawings are used to describe technical features of the disclosure. Configurations of devices, flowcharts of various processes, and the like, which are shown in the drawings, are not intended to be limiting, but are merely illustrative.

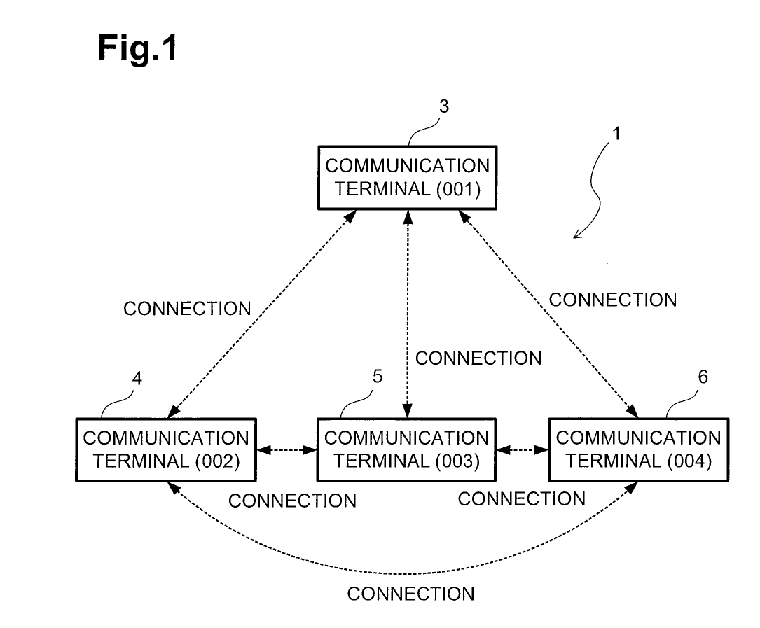

First, a configuration of the communication system 1 will be described with reference to FIG. 1. The communication system 1 includes the communication terminals 3, 4, 5, and 6 which are disposed at four different locations, respectively. Each of the communication terminals 3 to 6 connects to each of the other terminals via a network (not shown) and to perform communication of various data such as video, images, text, applications and audio, thereby enabling remote conferencing. Each of the communication terminals 3 to 6 includes a function for making/establishing a phone call or voice communication between users of terminals (e.g., an voice over IP phone function). As a call control protocol for implementing the IP phone function, for example, SIP (Session Initiation Protocol) is used. The communication terminals 3 to 6 may include various types of computing and communication devices such as a stationary personal computer, a portable terminal (e.g., mobile telecommunication device, laptop computer, personal data assistant (PDA)), or the like.

According to one or more aspects, identification information is allocated to each of the communication terminals 3 to 6. In SIP, for example, the identification information may include an SIP address. For example, as shown in FIG. 1, “001” is allocated to the communication terminal 3, “002” is allocated to the communication terminal 4, “003” is allocated to the communication terminal 5, and “004” is allocated to the communication terminal 6. In such an arrangement, to initiate a voice call to another terminal, a user designates an SIP address for a communication terminal of a specific user to be called.

The communication system 1 of the embodiment designates terminals which should transmit connection request signals and terminals which should receive connection request signals, with respect to each terminal, thereby efficiently achieving a multipoint full mesh connection in which all the communication terminals 3 to 6 belonging to the same network connect to each other. By specifying and identifying terminal that are responsible for transmitting connection request signals and terminals that are responsible for receiving request signals, communication system 1 may prevent overlapping and superfluous transmissions and communications between terminals 3 to 6.

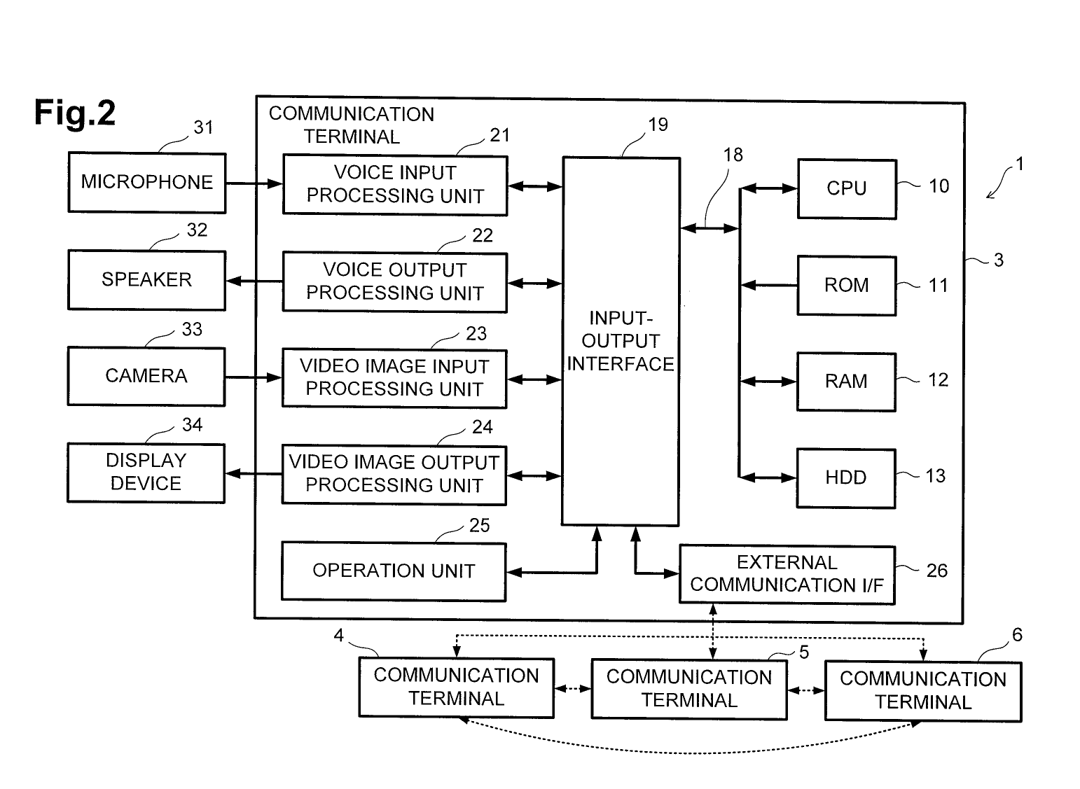

Next, an example electrical configuration of the communication terminal 3 will be described with reference to FIG. 2. The other communication terminals 4 to 6 may have the same configurations as that of the communication terminal 3, and thus the description thereof is omitted. The communication terminal 3 includes a processor (e.g., CPU 10) configured to execute instructions, perform mathematical calculations and control the communication terminal 3. A ROM 11, a RAM 12, a hard disk drive 13, and an input-output interface 19 are connected to the CPU 10 via a bus 18. Hereinafter, the hard disk drive 13 is referred to as “HDD 13”.

One or more computer readable media such as ROM 11 may store therein a program (e.g., computer readable instructions) for the communication terminal 3 to operate, initial values, and the like. The RAM 12 temporarily stores various pieces of information which are used in a control program and a communication program of the invention. The HDD 13 is a nonvolatile storage device which stores various pieces of information for the control program and the like. Instead of or in addition to the HDD 13, a storage device such as an EEPROM or a memory card may be used.

A voice input processing unit 21, a voice output processing unit 22, a video image input processing unit 23, a video image output processing unit 24, an operation unit 25, and an external communication I/F 26 are connected to the input-output interface 19. The voice input processing unit 21 processes an input of voice data from a microphone 31 which inputs a voice. The voice output processing unit 22 processes an operation of a speaker 32 which outputs a voice. The video image input processing unit 23 processes an input of image data from a camera 33 configured to capture a video image. The video image output processing unit 24 processes an operation of a display device 34 so as to cause display device 34 to produce an image on a display screen (not shown). The operation unit 25 is used for a user to input various instructions to the communication terminal 3. The external communication I/F 26 connects the communication terminal 3 to a network (not shown).

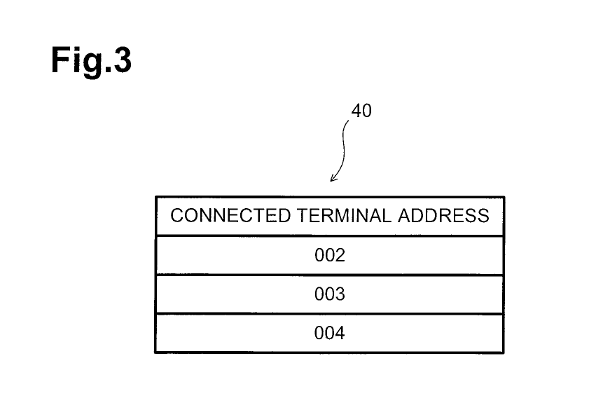

Next, a connected terminal list 40 will be described with reference to FIG. 3. The connected terminal list 40 is configured to manage and identify communication terminals which have completed a connection to the terminal storing the terminal list 40. Thus, each of the communication terminals (e.g., 3 to 6) may store its own connected terminal list 40 identifying and managing communication terminals which have completed a connection to the terminal. The connected terminal list 40 is stored in the HDD 13 (see FIG. 2). In the connected terminal list 40, for example, an SIP address of a communication terminal is registered as identification information for identifying one or more terminals currently connected to the terminal storing the connected terminal list 40 (a connected terminal). Identification information registered in terminal list 40 may include any type of information as long as the information identifies a connected terminal. In one or more examples, an IP address, a MAC address, or the like may be used other than (or in addition to) the SIP address.

In the example connected terminal list 40 of terminal 3 shown in FIG. 3, communication terminals 4, 5, and 6 have completed connections to the communication terminal 3 in this order. In this case, in the connected terminal list 40, the SIP address “002” of the communication terminal 4, the SIP address “003” of the communication terminal 5, and the SIP address “004” of the communication terminal 6 are registered in this order from the top. This order may signify that connection terminal 4 was first to connect, followed by terminals 5 and 6.

Next, a terminal designation list will be described. The terminal designation list is created in a multipoint connection start terminal, which is a first terminal which directs and manages a multipoint full mesh connection, for each connection destination terminal which connects to the multipoint connection start terminal. In the terminal designation list, a transmission source terminal responsible for transmitting a connection request signal, and a transmission destination terminal is configured to receive the connection request signal, are designated. Adjustment can be performed such that connection request signals do not overlap each other between each terminal and pair of terminals in the communication system 1. In particular, by pre-designating terminals as a terminal transmitting a connection request signal or a terminal receiving a connection request signal, connection request signals being sent by both terminals of a pair of terminals to each other may be avoided. Methods of designating a transmission destination terminal and a transmission source terminal will be described in further detail below.

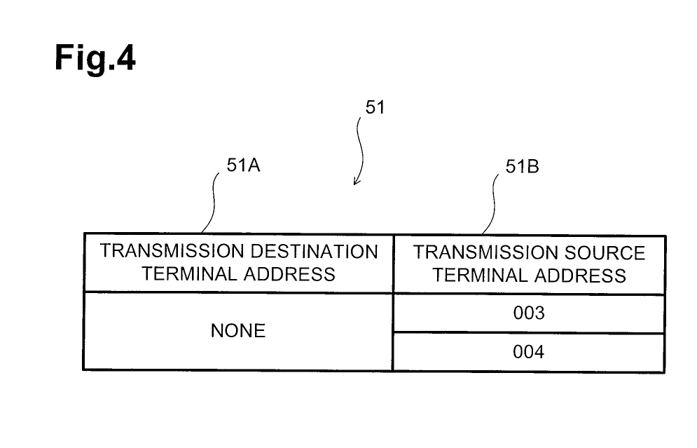

For example, in the case where the communication terminal 3 is a multipoint connection start terminal, terminal designation lists 51 to 53 shown in FIGS. 4 to 6, respectively, are created in the communication terminal 3 for the communication terminals 4 to 6, respectively. Communication terminals 4-6 are connection destination terminals for the communication terminal 3.

The contents of the terminal designation list 51 will be described with reference to FIG. 4. The terminal designation list 51 is provided with a transmission destination terminal address field 51A and a transmission source terminal address field 51B. In the transmission destination terminal address field 51A, an SIP address of a transmission destination terminal may be registered. In the transmission source terminal address field 51B, an SIP address of a transmission source terminal is registered. In this arrangement, the transmission destination terminal address field 51A does not include an SIP address since the transmission destination terminal is itself (i.e., communication terminal 4). In some arrangements, the terminal's own address may be registered. In the transmission source terminal address field 51B, “003” and “004” are registered. Thus, this means that the communication terminal 4 does not need to transmit any connection request signal to terminals 5 and 6, instead, terminal 4 only has to receive connection request signals transmitted from the communication terminals 5 and 6.

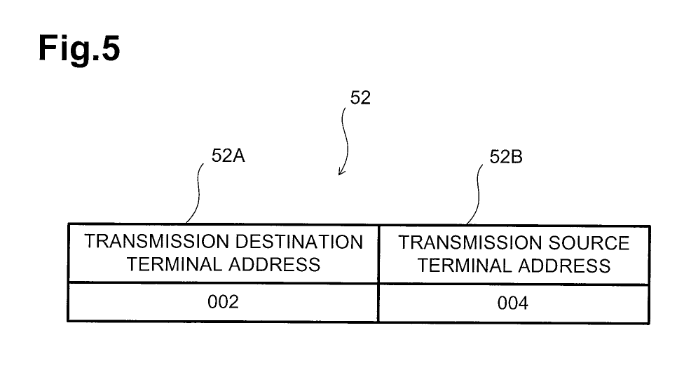

The contents of the terminal designation list 52 will be described with reference to FIG. 5. Similarly, in the terminal designation list 52 is provided with a transmission destination terminal address field 52A and a transmission source terminal address field 52B. For example, in the transmission destination terminal address field 52A, “002” is registered. In the transmission source terminal address field 52B, “004” is registered. Thus, this means that the communication terminal 5 only has to transmit the connection request signal to the communication terminal 4 and to receive a connection request signal transmitted from the communication terminal 6. Accordingly, terminal 5 does not need to transmit a connection request signal to communication terminal 6 and should not expect a connection request signal from terminal 4.

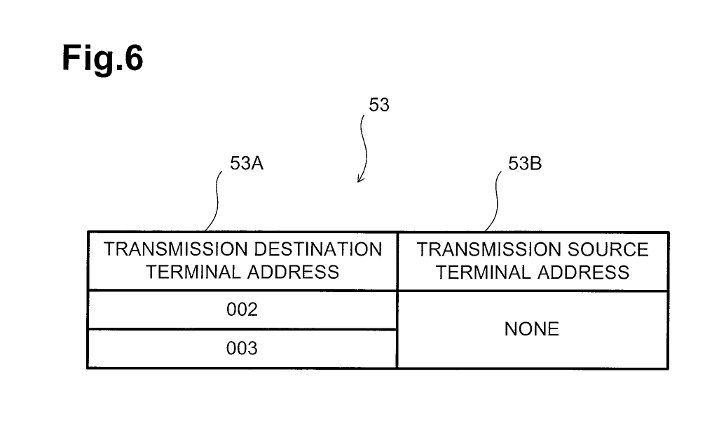

The contents of the terminal designation list 53 will be described with reference to FIG. 6. The terminal designation list 53 is also provided with a transmission destination terminal address field 53A and a transmission source terminal address field 53B. For example, in the transmission destination terminal address field 53A, “002” and “003” are registered. In the transmission source terminal address field 53B, nothing is registered. Thus, this means that the communication terminal 6 only has to transmit the connection request signals to the communication terminals 4 and 5 and connection request signals are not transmitted from the terminals at other locations thereto.

Then, in the communication terminals 4 to 6, according to these terminal designation lists 51 to 53, connection request signals are transmitted to or received from the other communication terminals at other locations. Thus, connection request signals can be prevented from overlapping each other between terminals.

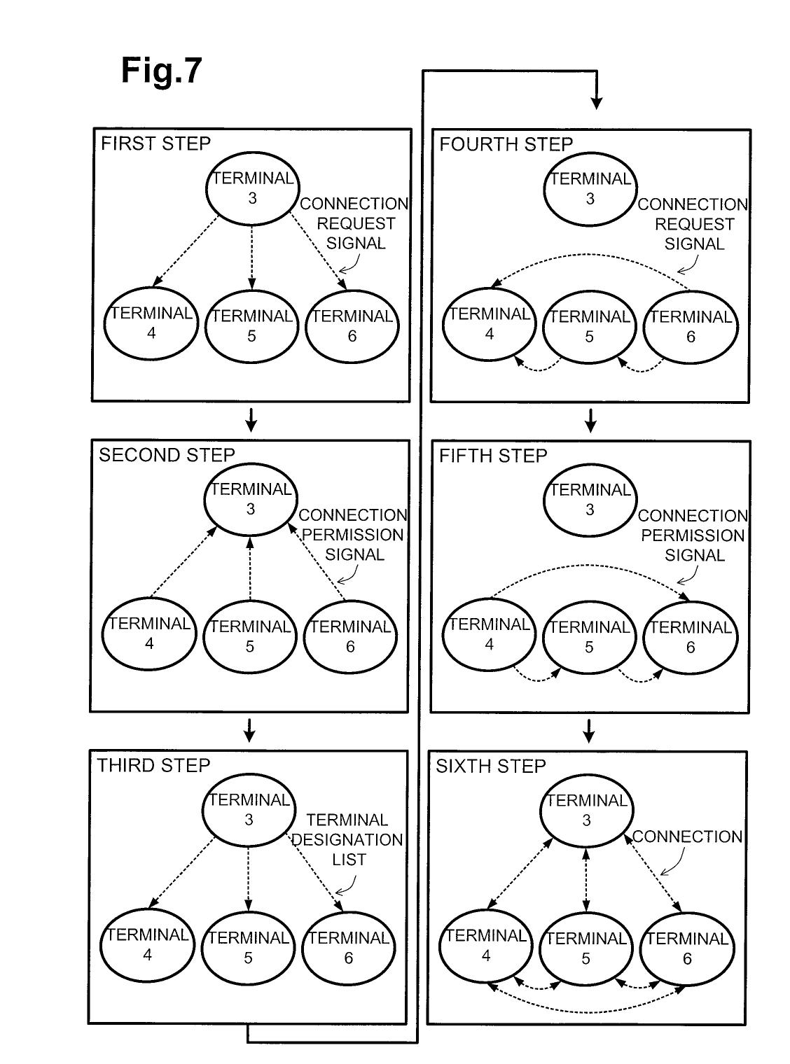

Next, a communication procedure of the multipoint full mesh connection in the communication system 1 will be described with reference to FIG. 7. In FIG. 7, the communication procedure of the multipoint full mesh connection is divided into six steps. Note that, in FIG. 7, due to limitations of space, the communication terminal 3 is abbreviated as “terminal 3”, the communication terminal 4 is abbreviated as “terminal 4”, the communication terminal 5 is abbreviated as “terminal 5”, and the communication terminal 6 is abbreviated as “terminal 6”. In addition, the description is provided based on communication terminal 3 operating as a multipoint connection start terminal.

At the first step, connection request signals are transmitted from the communication terminal 3 to each of the communication terminals 4 to 6.

Next, in the second step, connection permission signals which permit connections are transmitted from the communication terminals 4 to 6, which have received the connection request signals, to the communication terminal 3. Thus, the communication terminal 3 is connected to the communication terminal 4, the communication terminal, 5, and the communication terminal 6.

Next, in the third step, the communication terminal 3 creates the terminal designation list 51 to 53 (see FIGS. 4 to 6) based on the reception order of the connection permission signals transmitted from the communication terminals 4 to 6. Then, the terminal designation list 51 (see FIG. 4) is transmitted to the communication terminal 4, the terminal designation list 52 (see FIG. 5) is transmitted to the communication terminal 5, and the terminal designation list 53 (see FIG. 6) is transmitted to the communication terminal 6.

Next, in the fourth step, the communication terminals 4 to 6 perform transmission or reception of connection request signals as specified in the terminal designation lists 51 to 53, respectively. For example, the communication terminal 4 might only receive connection request signals transmitted from the communication terminals 5 and 6 while the communication terminal 5 is responsible for transmitting the connection request signal to the communication terminal 4 and receiving a connection request signal transmitted from the communication terminal 6. The communication terminal 6 transmits the connection request signals to the communication terminals 4 and 5. In this manner, between each terminal, connection request signals do not overlap each other and connections are efficiently established. Thus, wasteful communication can be eliminated.

Next, in the fifth step, in the communication terminals 4 and 5 which have received the connection request signals, on the basis of the terminal designation lists 51 and 52, connection permission signals are transmitted to the terminals from which the connection request signals were received. For example, the connection permission signals are transmitted from the communication terminal 4 to the communication terminals 5 and 6. The connection permission signal is transmitted from the communication terminal 5 to the communication terminal 6.

Finally, in the sixth step, the communication terminal 4 is connected to the communication terminal 5, the communication terminal 4 is connected to the communication terminal 6, and the communication terminal 5 is connected to the communication terminal 6. In combination with the connections completed in the second step (e.g., with communication terminal 3), the multipoint full mesh connection in the communication system 1 is completed. In this manner, the connection request signals do not overlap each other at all and the connections can be efficiently established in a short time. Thus, wasteful communication can be eliminated.

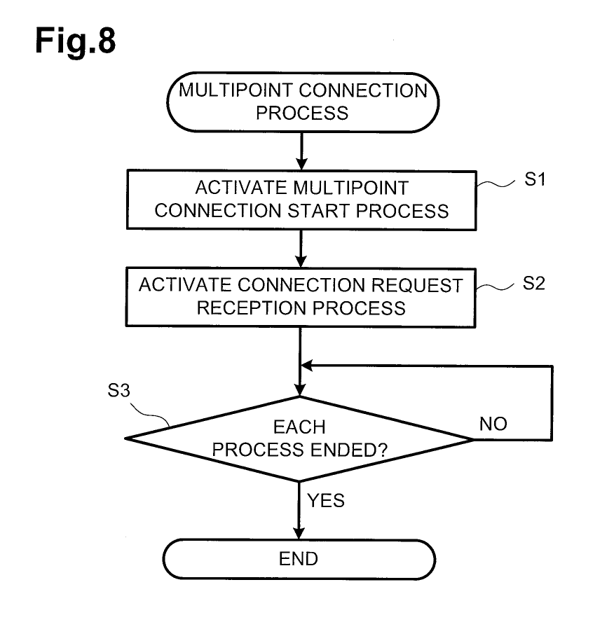

Next, a multipoint connection process performed by the CPU 10 of each terminal in order to achieve the multipoint full mesh connection, will be described with reference to a flowchart in FIG. 8. For example, when the power is turned on, a multipoint connection program stored in the HDD 13 (see FIG. 2) is called and this process is performed. Note that activation of this process is performed when the power is turned on, but it may be performed by a predetermined operation.

First, a multipoint connection start process is activated (S1). The multipoint connection start process is a process of creating a terminal designation list and transmitting the terminal designation list to each connection destination terminal, when a terminal serves as a multipoint connection start terminal. For example, a user may initiate a mesh network (e.g., a video or audio conferencing session) from his or her terminal. Thus, the terminal from which the mesh network is initiated may act as the multipoint connection start terminal. Next, a connection request reception process is activated (S2). The connection request reception process is a process of receiving a connection request signal from a multipoint connection start terminal, and transmitting or receiving a connection request signal to or from the terminal at another location on the basis of a terminal designation list transmitted from the multipoint connection start terminal, thereby establishing a connection between each terminal. Note that the multipoint connection start process at S1 is a process configured to perform the first and third steps in FIG. 7, and the connection request reception process at S2 is a process configured to perform the second and fourth to sixth steps in FIG. 7. A process at S3 will be described later.

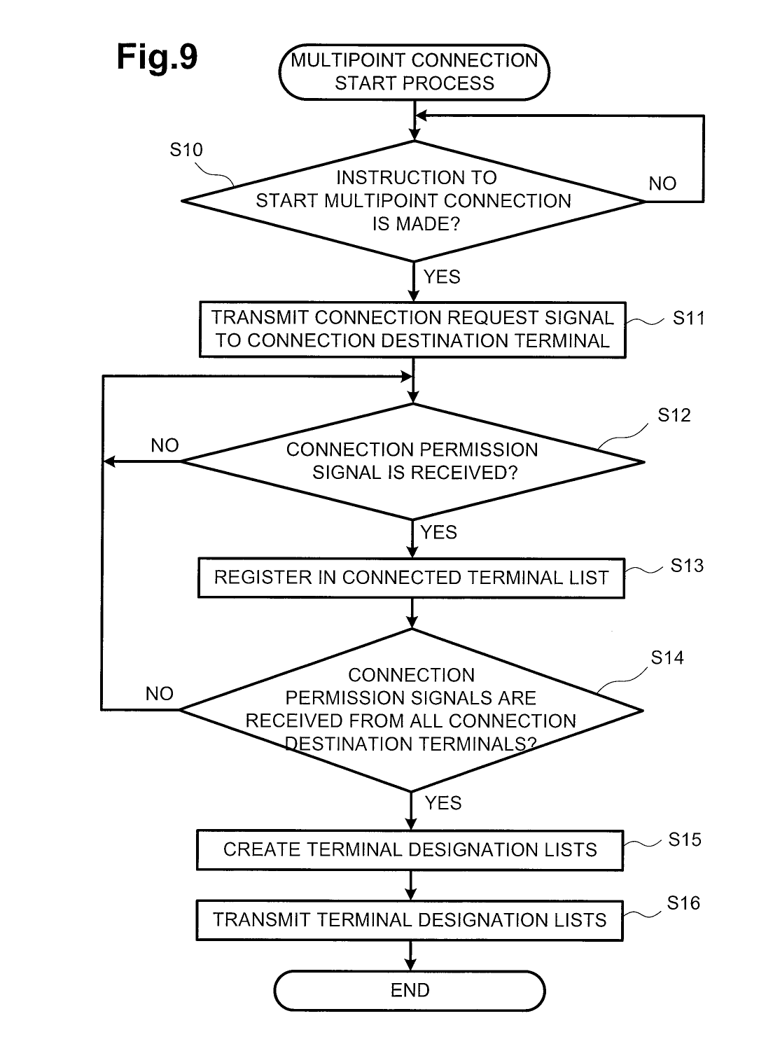

Next, the multipoint connection start process will be described with reference to a flowchart in FIG. 9. First, a determination is made at a terminal (e.g., communication terminal 3) as to whether an instruction to start a multipoint connection has been made (S10). For example, when a multipoint connection start button (not shown) displayed on the display screen of the display device 34 is clicked with a mouse, it is determined that an instruction to start a multipoint connection has been made. When an instruction to start a multipoint connection has not been made (S10: NO), the processing returns to S10 to be in a standby state.

When an instruction to start a multipoint connection has been made (S10: YES), the terminal at which the instruction is received or inputted (e.g., communication terminal 3) may become the multipoint connection start terminal. Additionally, the user at the multipoint connection start terminal may specify one or more other terminals that are invited to join the network. In a particular example, the user may identify communication terminals 4 to 6. Accordingly, communication terminals 4 to 6 may be designated as connection destination terminals based on the user specification. In one or more arrangements, the connection destination terminals may be automatically identified by a connection destination terminal list (not shown) stored in the HDD 13 (see FIG. 2). The connection destination terminal list may also, in another example, be generated based on terminals/users that have requested membership in a network. Accordingly, a user at communication terminal 4, for example, may indicate a desire to join a network by transmitting a request to communication terminal 3. Communication terminal 3 may then store the address of communication terminal 4 in the connection destination terminal list.

In the connection destination terminal list, identification information (e.g., SIP addresses) of terminals planning to join a multipoint full mesh connection with the communication terminal 3 is previously registered. Thus, connection request signals are transmitted to the communication terminals 4 to 6 registered in the connection destination terminal list (S11, e.g., first step in FIG. 7). The communication terminals 4 to 6 which have received the connection request signals transmit connection permission signals to the communication terminal 3 for permitting the communication terminal 3 to perform and establish connections (e.g., second step in FIG. 7).

Next, it is determined whether a connection permission signal has been received from any of the communication terminals 4 to 6 (S12). Until a connection permission signal is received (S12: NO), the processing returns to S12, e.g., to a standby state. When a connection permission signal has been received (S12: YES), an SIP address of a communication terminal which has transmitted the connection permission signal is registered in the connected terminal list 40 (see FIG. 3) (S13).

Further, it is determined whether connection permission signals have been received from all the connection destination terminals (S14). Here, this determination is performed by whether all of the SIP addresses in the connection destination terminal list (not shown) stored in the HDD 13 (see FIG. 2) agrees with or matches the SIP addresses in the connected terminal list 40 (see FIG. 3) stored in the HDD 13. When there is any connection destination terminal from which a connection permission signal has not been received (S14: NO), the processing returns to a standby state in S12, and it is subsequently determined whether a connection permission signal has been received.

Then, when a connection permission signal has been received (S12: YES), an SIP address of a communication terminal which has transmitted the connection permission signal is similarly registered in the connected terminal list 40 (see FIG. 3) (S13). When connection permission signals have been received from all of the connection destination terminals (S14: YES), the terminal designation list 51, 52, and 53 for the communication terminals 4, 5, and 6 are created (S15).

Here, a method of creating the terminal designation lists 51 to 53 will be described. In each of the terminal designation lists 51 to 53, each of the communication terminals 4 to 6 is designated as a transmission destination terminal or a transmission source terminal. This process is performed based on the reception order of the connection permission signals transmitted from the connection destination terminals. For example, a connection destination terminal whose reception order (order in which the connection permission signal was received) is earlier is designated as a transmission destination terminal, and a connection destination terminal whose reception order is later is designated as a transmission source terminal.

In a particular example, in the communication terminal 3, when receiving connection permission signals from the communication terminals 4, 5, and 6 in this order, the communication terminal 4 whose reception order of the connection permission signal is earliest is designated as a transmission destination terminal, and the communication terminal 6 whose reception order of the connection permission signal is latest is designated as a transmission source terminal. The communication terminal 5 is designated as a transmission source terminal in the terminal designation list 51 (see FIG. 4) for the communication terminal 4 whose reception order is earlier than that of the communication terminal 5. The communication terminal 5 is designated as a transmission destination terminal in the terminal designation list 53 (see FIG. 6) for the communication terminal 6 whose reception order is later than that of the communication terminal 5. Under such a condition, a transmission destination terminal and a transmission source terminal are designated.

As shown in FIG. 4, in the terminal designation list 51 for the communication terminal 4, a transmission destination terminal is itself (the communication terminal 4), and thus nothing is registered in the transmission destination terminal address field 51A. Alternatively, the terminal designation list 51 may specify terminal 4 in destination terminal address field 51A. In the transmission source terminal address field 51B, the SIP addresses “003” and “004” of the communication terminals 5 and 6 are registered. The terminal designation list 51 is created in this manner, and stored in the HDD 13 (see FIG. 2).

As shown in FIG. 5, in the terminal designation list 52 for the communication terminal 5, the SIP address “002” of the communication terminal 3 is registered in the transmission destination terminal address field 52A. The SIP address “004” of the communication terminal 6 is registered in the transmission source terminal address field 52B. The terminal designation list 52 is created in this manner, and stored in the HDD 13 (see FIG. 2).

As shown in FIG. 6, in the terminal designation list 53 for the communication terminal 6, the SIP addresses “002” and “003” of the communication terminals 4 and 5 are registered in the transmission destination terminal address field 53A. A transmission source terminal is itself (the communication terminal 6), and thus nothing is registered in the transmission source terminal address field 53B. Alternatively, the address of terminal 6 may be registered in field 53B. The terminal designation list 53 is created in this manner, and stored in the HDD 13 (see FIG. 2).

Then, the terminal designation lists 51 to 53 stored in the HDD 13 (see FIG. 2) are transmitted to the communication terminals 4 to 6, respectively (S16, third step in FIG. 7). For example, the terminal designation list 51 is transmitted to the communication terminal 4, the terminal designation list 52 is transmitted to the communication terminal 5, and the terminal designation list 53 is transmitted to the communication terminal 6. Then, the multipoint connection start process ends.

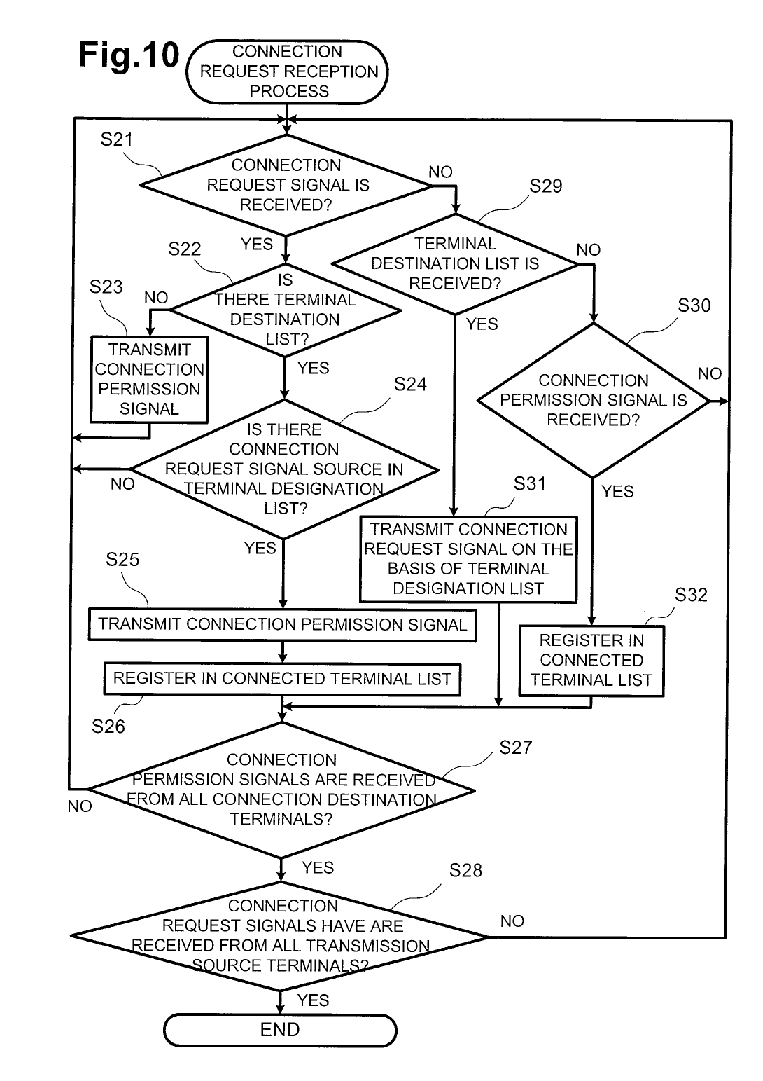

Next, the connection request reception process (which may be performed by each of communication terminals 4-6, for example) will be described with reference to a flowchart in FIG. 10. In this process, first, it is determined whether a connection request signal, a terminal designation list, or a connection permission signal has been received from a terminal at another location (S21, S29, S30). When none of a connection request signal, a terminal designation list, and a connection permission signal has been received (S21: NO, S29: NO, S30: NO), the processing returns to S21, and it is subsequently determined whether these pieces of information have been received.

First, the case where a connection request signal has been received will be described. When a connection request signal has been received from the terminal at another location (S21: YES), it is determined whether a terminal designation list transmitted from the multipoint connection start terminal has been stored in the HDD 13 (see FIG. 2) of the terminal making the determination (e.g., one of terminals 4-6)(S22). When the terminal designation list has not been stored (S22: NO), a connection permission signal is transmitted to a terminal which is a transmission source of the connection request signal (S23). For example, this scenario may correspond to a case where a connection request signal is received from the multipoint connection start terminal and a connection permission signal is transmitted to the multipoint connection start terminal (see second step in FIG. 7). Then, the processing returns to S21, and it is determined whether a connection request signal, a terminal designation list, or a connection permission signal has been received.

On the other hand, when a connection request signal has been received from the terminal at another location (S21: YES) and a terminal designation list transmitted from the multipoint connection start terminal has been already stored in the HDD 13 (see FIG. 2) (S22: YES), it is determined whether an SIP address of a transmission source terminal which has transmitted the connection request signal is present in the transmission source terminal address field of the terminal designation list (S24). For example, in the communication terminal 4, “003” and “004” are stored in the transmission source terminal address field 51B of the terminal designation list 51 (see FIG. 4).

Thus, when the transmission source which has transmitted the connection request signal is the communication terminal 5 or 6 (S24: YES), the SIP address matches with an address in the transmission source terminal address field of the terminal designation list, and thus a connection permission signal is transmitted to the transmission source terminal of the connection request signal (S25, fifth step in FIG. 7). When the connection permission signal is transmitted, a connection is completed between these terminals. Thus, the SIP address of the communication terminal which is the transmission source of the connection permission signal is registered in the connected terminal list 40 of the present terminal (e.g., the terminal receiving the connection permission signal) (S26).

On the other hand, when the SIP address of the transmission source of the connection request signal is not present in the transmission source terminal address field 51B (S24: NO), a connection request signal should not be received from the terminal, and thus the processing returns to S21 without doing anything, and the same process is repeated until a connection request signal, a terminal designation list, or a connection permission signal is received.

Next, the case where a terminal designation list has been received will be described. When a terminal designation list has been received from the multipoint connection start terminal (S21: NO, S29: YES), the terminal list is stored in the HDD 13 of the terminal at which the designation list is received (see FIG. 2), and a connection request signal is transmitted to a transmission destination terminal designated in the terminal designation list (S31). For example, in the communication terminal 5, the SIP address of the communication terminal 4 has been registered in the transmission destination terminal address field 52A (see FIG. 5) of the terminal designation list 52. Thus, a connection request signal is transmitted to the communication terminal 4.

Next, the case where a connection permission signal has been received will be described. For example, when a connection request signal is transmitted to the terminal at another location on the basis of a terminal designation list and then a connection permission signal is received from the terminal (S21: NO, S29: NO, S30: YES), a connection is completed between these terminals. Thus, the SIP address of the communication terminal which is the transmission source of the connection permission signal is registered in the connected terminal list 40 stored in the present terminal (S32).

When a connection request signal, a terminal designation list, or a connection request signal has been received and each process is performed on the basis of the received information as described above, it is determined whether connection permission signals have been received from all the transmission destination terminals, on the basis of the connected terminal list 40 of the communication terminal and the terminal designation list stored in the HDD 13 (see FIG. 2) (S27). For example, when there is any SIP address which is not registered in the connected terminal list 40, among the SIP addresses registered in the transmission destination terminal address field of the terminal designation list, there is a transmission destination terminal from which a connection permission signal has not been received. In this case (S27: NO), the processing returns to S21, and the same process is repeated until connection permission signals are received from all the transmission destination terminals.

Then, when connection permission signals have been received from all the transmission destination terminals (S27: YES), it is determined whether connection request signals have been received from all the transmission source terminals, on the basis of the terminal designation list stored in the HDD 13 of the communication terminal (see FIG. 2) (S28). When there is a transmission source terminal from which a connection request signal has not been received (S28: NO), the processing returns to S21, and the same process is repeated until connection permission signals are received from all the transmission source terminals. Then, when connection request signals have been received from all the transmission source terminals (S28: YES), it means that all the connection request signals and connection permission signals have been received on the basis of the terminal designation lists, and thus the connection request reception process ends.

Referring next to the flowchart shown in FIG. 8, in the multipoint connection process, it is determined whether both of the multipoint connection start process and the connection request reception process, which are activated at S1 and S2, have ended (S3). When either process has not ended (S3: NO), the multipoint full mesh connection is not completed, and thus the processing returns to S3 to be in a standby state. When both processes have ended (S3: YES), connections have been established between all the terminals as shown at the sixth step in FIG. 7, and thus the multipoint connection process ends. In this manner, the multipoint full mesh connection is completed.

As described above, in the communication system 1 of this embodiment, in the multipoint connection start terminal, a terminal designation list is created for each connection destination terminal for the multipoint connection start terminal. In the terminal designation list, a transmission destination terminal which is a terminal to which a connection request signal should be transmitted, and a transmission source terminal which is a terminal from which a connection request signal should be received, are designated. These terminal designation lists are transmitted to the connection destination terminals, respectively. On the basis of the terminal designation list received from the multipoint connection start terminal, each connection destination terminal transmits or receives a connection request signal to or from one or more communication terminals at one or more other locations. Thus, connection request signals do not overlap each other between terminal pairs and connections can be efficiently established between terminals in a short time. Thus, wasteful communication can be eliminated.

Further, in this embodiment, in particular, in each terminal designation list, a transmission destination terminal and a transmission source terminal are designated on the basis of the reception order of connection permission signals transmitted from the connection destination terminals. Specifically, a connection destination terminal whose reception order is earlier is designated as a transmission destination terminal, and a connection destination terminal whose reception order is later is designated as a transmission source terminal. By so doing, a transmission destination terminal and a transmission source terminal can be efficiently and easily designated. In addition, for a connection destination terminal which transmits a connection permission signal to the multipoint connection start terminal earlier than other communication terminals, the number of transmission destination terminals to which connection request signals should be transmitted becomes small or is minimized, and thus the load of the process of transmitting the connection request signal can be reduced.

By designating later responding terminals as transmission source terminals, a multipoint connection start terminal may insure that connection request signals are being sent to terminals which have received the terminal designation list/information. For example, if a first responding terminal such as terminal 4 were designated as a transmission source terminal for terminal 5, terminal 5 might not have received the terminal designation list/information when a connection request signal is transmitted from terminal 4. Accordingly, terminal 5 might ignore the connection request signal since it is not aware of its role with respect to transmission destination terminal 4. In contrast, by designating the later responding terminals as transmission source terminals, the multipoint connection terminal may be able to better guarantee that the earlier responding terminals designated as transmission destination terminals have received the terminal designation list/information.

Note that the disclosure is not limited to the above embodiment and various modifications are possible. For example, in the above embodiment, in each terminal list created in the multipoint connection start terminal, identification information of a transmission destination terminal and identification information of a transmission source terminal are registered. For example, in the terminal designation list 52 shown in FIG. 5, only the SIP addresses of each terminal is registered in the transmission destination terminal address field 52A and the transmission source terminal address field 52B.

In an alternate or additional arrangement, for example, an authentication key for authenticating a connection is allocated to each connection between connection destination terminals. Accordingly, a terminal designation list including the authentication key is created. In addition, each connection destination terminal confirms that an authentication key transmitted together with a connection request signal matches the authentication key included in the terminal designation list, and establishes a connection upon confirming authentication. By so doing, a connection to another terminal attempting to camouflage or disguise itself as a terminal which should be connected to the communication terminal can be detected and refused.

Establishment of a multipoint full mesh connection using a terminal designation list including an authentication key, will now be described in further detail. Note that this arrangement in which authentication keys are used might only differ from the above embodiment with respect to a part of the structure of the terminal designation list, a part of the multipoint connection start process, and a part of the connection request process. The remaining structures, systems, processes may be the same. Thus, the following description will primarily focus on the differences. With regard to the process performed by the CPU 10, the same processes as those in the above-described flowcharts are designated by the same step numerals, and described.

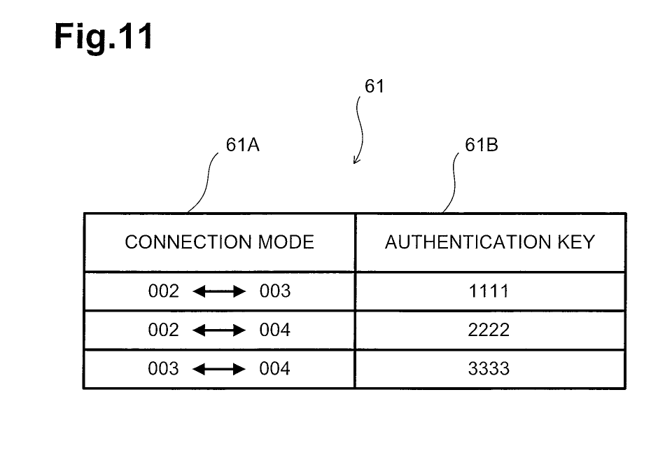

First, an authentication key allocation list 61 will be described with reference to FIG. 11. The authentication key allocation list 61 is stored in the HDD 13 (see FIG. 2) of the multipoint connection start terminal. In the authentication key allocation list 61, an authentication key is set so as to correspond to each of the connection modes of the communication terminals 4 to 6 which are the connection destination terminals for the communication terminal 3. For example, the number of authentication keys defined or generated for the authentication key allocation list 61 may correspond to the number of terminals to be connected and a number of connections to be established between terminals. In a particular example, the number of authentication keys may correspond to a number of connections between connection destination terminals (e.g., not including connections with the multipoint connection start terminal).

For example, an authentication key “1111” is allocated to a connection of the communication terminal 4 (the SIP address “002”) and the communication terminal 5 (the SIP address “003”). An authentication key “2222” is allocated to a connection of the communication terminal 4 (the SIP address “002”) and the communication terminal 6 (the SIP address “004”). An authentication key “3333” is allocated to a connection of the communication terminal 5 (the SIP address “003”) and the communication terminal 6 (the SIP address “004”).

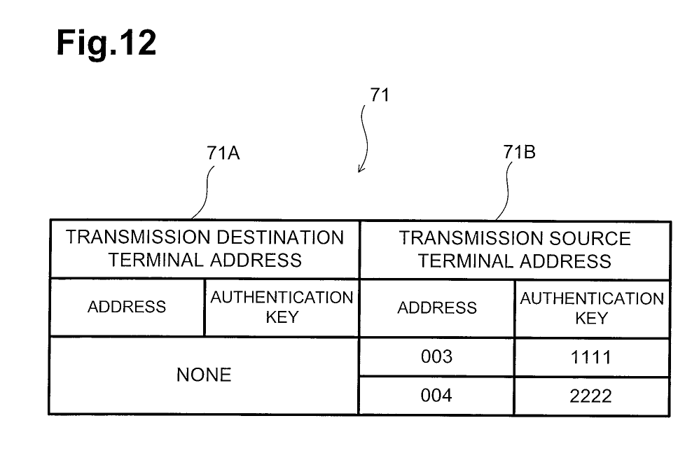

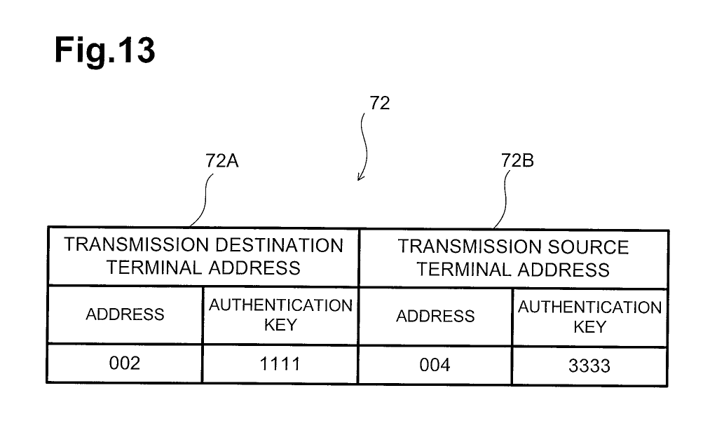

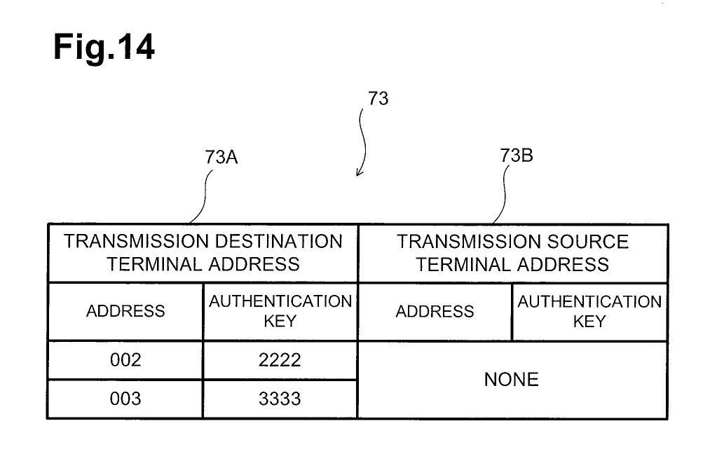

Next, terminal designation lists including authentication keys will be described with reference to FIGS. 12 to 14. A terminal designation list 71 in FIG. 12 is created for the communication terminal 4, and is obtained by providing an authentication key to the terminal designation list 51 in FIG. 4. A terminal designation list 72 in FIG. 13 is created for the communication terminal 5, and is obtained by providing an authentication key to the terminal designation list 52 in FIG. 5. A terminal designation list 73 in FIG. 14 is created for the communication terminal 6, and is obtained by providing an authentication key to the terminal designation list 53 in FIG. 6.

In the terminal designation list 71 shown in FIG. 12, a transmission destination terminal information field 71A and a transmission source terminal information field 71B are provided. Nothing is registered in the transmission destination terminal information field 71A. In the transmission source terminal information field 71B, in addition to the SIP addresses “003” and “004” of the communication terminals 5 and 6, an authentication key is registered so as to correspond to each address.

Referring to the authentication key allocation list 61 in FIG. 11, the authentication key “1111” is allocated to the connection of the communication terminal 4 (the SIP address “002”) and the communication terminal 5 (the SIP address “003”). The authentication key “2222” is allocated to the connection of the communication terminal 4 (the SIP address “002”) and the communication terminal 6 (the SIP address “004”). Thus, in the transmission source terminal information field 71B, the authentication key “1111” is set for the SIP address “003”, and the authentication key “2222” is set for the SIP address “004”.

In the terminal designation list 72 shown in FIG. 13 as well, a transmission destination terminal information field 72A and a transmission source terminal information field 72B are provided. In the transmission destination terminal information field 72A, in addition to the SIP address “002” of the communication terminal 4, an authentication key corresponding to the address is registered. In the transmission source terminal information field 72B, in addition to the SIP address “004” of the communication terminal 6, an authentication key corresponding to the address is registered.

Referring to the authentication key allocation list 61 in FIG. 11, the authentication key “1111” is allocated to the connection of the communication terminal 5 (the SIP address “003”) and the communication terminal 4 (the SIP address “002”). The authentication key “3333” is allocated to the connection of the communication terminal 5 (the SIP address “003”) and the communication terminal 6 (the SIP address “004”). Thus, in the transmission destination terminal information field 72A, the authentication key “1111” is set for the SIP address “002”. In the transmission source terminal information field 72B, the authentication key “3333” is set for the SIP address “004”.

In the terminal designation list 73 shown in FIG. 14 as well, a transmission destination terminal information field 73A and a transmission source terminal information field 73B are provided. In the transmission destination terminal information field 73A, in addition to the SIP addresses “002” and “003” of the communication terminals 4 and 5, an authentication key is registered so as to correspond to each address. Nothing is registered in the transmission source terminal information field 72B.

Referring to the authentication key allocation list 61 in FIG. 11, the authentication key “2222” is allocated to the connection of the communication terminal 6 (the SIP address “004”) and the communication terminal 4 (the SIP address “002”). The authentication key “3333” is allocated to the connection of the communication terminal 6 (the SIP address “004”) and the communication terminal 5 (the SIP address “003”). Thus, in the transmission destination terminal information field 73A, the authentication key “2222” is set for the SIP address “002”, and the authentication key “3333” is set for the SIP address “003”.

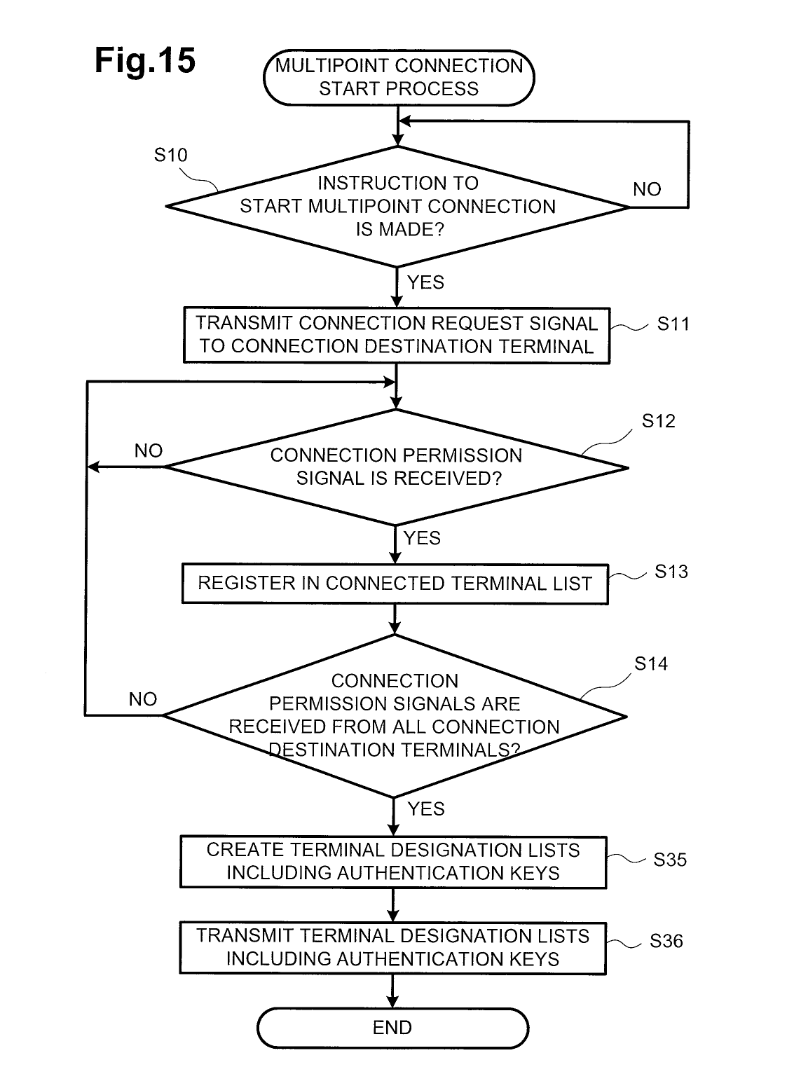

Next, a multipoint connection start process of the CPU 10 in the alternate embodiment will be described with reference to a flowchart in FIG. 15. In this process, processes at S10 to S14 are performed similarly to the flowchart in FIG. 9 of the above embodiment. Then, when it is determined that connection permission signals have been received from all the connection destination terminals (S14: YES), the terminal designation lists 71 to 73 including the authentication keys are created (S35). The terminal designation lists 71 to 73 are similar to those described in the above previous embodiment with respect to designation of a transmission destination terminal and a transmission source terminal. However, terminal designation lists 71 to 73 differ from the terminal designation lists (e.g., 51 to 53) of the previous embodiment in that an authentication key is provided to each SIP address. In one example, a single authentication key may be defined for a connection between a pair of terminals. Then, the terminal designation list 71 is transmitted to the communication terminal 4, the terminal designation list 72 is transmitted to the communication terminal 5, and the terminal designation list 73 is transmitted to the communication terminal 6 (S36). Then, the multipoint connection start process ends.

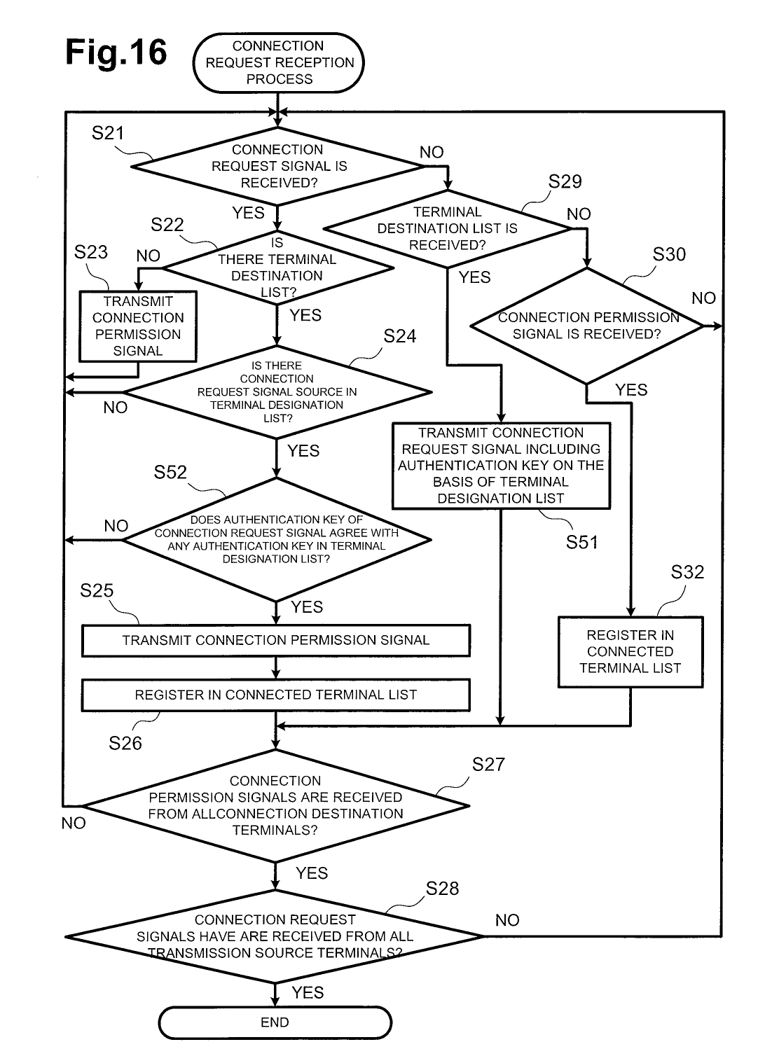

Next, a connection request reception process of the CPU 10 in the alternate embodiment will be described with reference to a flowchart in FIG. 16. In this process as well, some steps or functions may be performed similarly to the flowchart in FIG. 10 of the above embodiment. Processes labeled with the same step numerals as those in FIG. 10 represent the same processes as those in the connection request reception process of the previously described embodiment. For example, in the communication terminal 5, when the terminal designation list 72 (see FIG. 13) is received from the communication terminal 3 which is the multipoint connection start terminal (S29: YES), the SIP address “002” of the communication terminal 4 and the authentication key “1111” are registered in the transmission destination terminal information field 72A of the terminal designation list 72. Thus, a connection request signal and the authentication key “1111” are transmitted from the communication terminal 5 to the communication terminal 4 (S51).

Then, when a connection request signal has been received from the communication terminal at another location (S21: YES) and a terminal designation list has already been stored in the HDD 13 (S22: YES), it is determined, as described above, whether an SIP address of a communication terminal corresponding to the transmission source of the connection request signal has been registered in the transmission source terminal address field of the terminal designation list (S24).

Further, when the SIP address of the terminal corresponding to the transmission source of the connection request signal has been registered in the transmission source terminal address field of the terminal designation list (S24: YES), it is determined whether an authentication key of the connection request signal matches the authentication key registered for the connection with the transmission source terminal (e.g., in the information field for the transmission source terminal of the terminal designation list) (S52). For example, even when the SIP address of the transmission source which has transmitted the connection request signal matches an SIP address registered in the transmission source terminal address field of the terminal designation list, there is the possibility that the connection request signal was transmitted by another terminal camouflaging or disguising itself as an authorized transmission source terminal.

Therefore, it is determined whether the authentication key of the connection request signal matches the corresponding authentication key in the terminal designation list (S52). For example, in the communication terminal 4, when a connection request signal and an authentication key have been received from the communication terminal 5, the authentication key transmitted together with the connection request signal is “1111” as described above. Here, referring to the terminal designation list 71 (see FIG. 12) transmitted to the communication terminal 4, the authentication key “1111” has been registered for the SIP address “003” registered in the transmission source terminal information field 71B. “003” is the SIP address of the communication terminal 5. In other words, since the authentication key allocated to the connection request signal matches a corresponding authentication key in the terminal designation list 71 (S52: YES), a connection permission signal is transmitted to the communication terminal 5 which has transmitted the connection request signal (S25).

When the authentication key of the connection request signal does not match a corresponding authentication key in the terminal designation list (S52: NO), there is a high possibility that the connection request signal is from another terminal camouflaging or disguising itself as a transmission source terminal, and thus the processing may return to S21 without performing any further action such as completing the connection. Instead, the processing may begin monitoring once again to determine whether a next connection request signal has been received. Subsequent processes are the same as those in the previously described embodiment.

By allocating an authentication key to each connection between connection destination terminals, a terminal designation list including the authentication key is created, thereby providing confirmation that an authentication key provided to a connection request signal matches a corresponding authentication key registered in the terminal designation list. In some arrangements, a connection might only be established upon confirmation. By so doing, a connection to another terminal which camouflages or disguise itself as a terminal which should be connected to the communication terminal can be detected and refused.

Further, in addition to the alternate embodiment involving authentication keys discussed above, various other embodiments and modifications are possible. For example, with respect to the multipoint connection start process shown in FIG. 9, when connection permission signals are received from all the connection destination terminals (e.g., communication terminals 4 to 6) for the communication terminal 3 (S14: YES), the terminal designation lists 51 to 53 are created (S15). In a particular example, each time a connection permission signal is received, a terminal designation list for a transmission source of the connection permission signal may be created and transmitted to the connection destination terminal which has transmitted the connection permission signal.

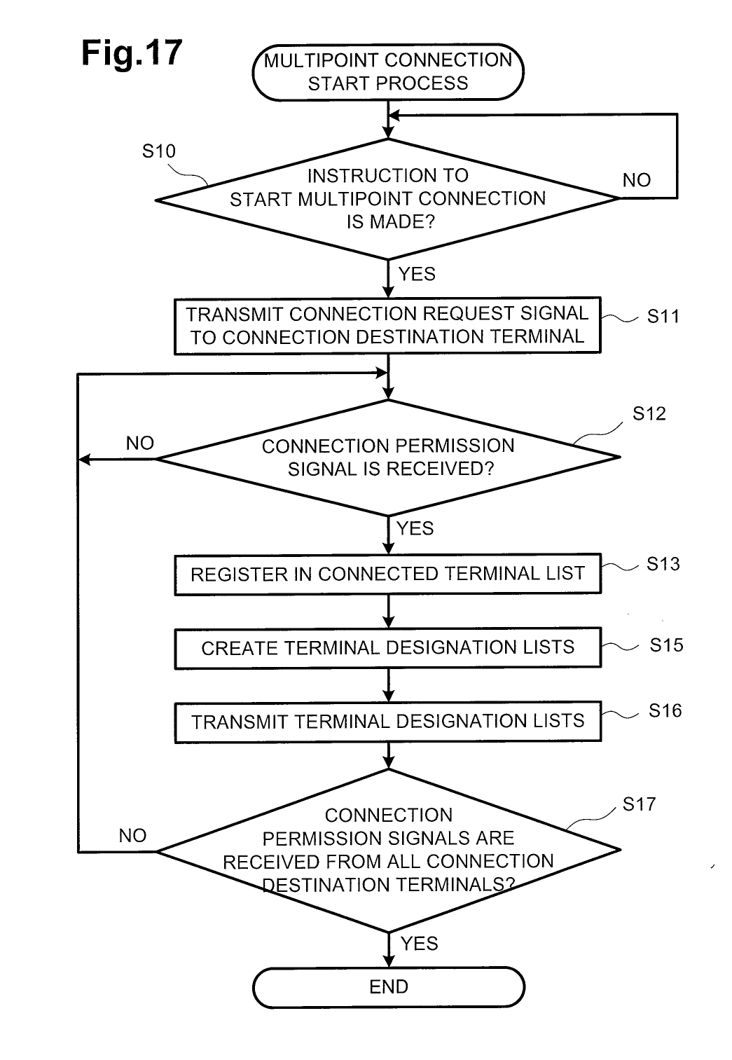

In an alternate embodiment or arrangement, a timing of creating a terminal designation list may be changed in the multipoint connection start process in FIG. 9, as is further described with reference to the flowchart of FIG. 17. In this process, processes at S10 to S12 are performed similarly to the corresponding processes S10 to S12 in the flowchart of FIG. 9. Then, when a connection permission signal is received from a connection destination terminal (S12: YES), the SIP address of the communication terminal which has transmitted the connection permission signal is registered in the connected terminal list 40 (see FIG. 3) (S13).

Next, a terminal designation list for the connection destination terminal from which the connection permission signal was transmitted is created without waiting for reception of a connection permission signal from another connection destination terminal or all of the connection destination terminals (S15). As described in previous embodiments, in the terminal designation list, categorization of a transmission destination terminal and a transmission source terminal is determined according to the reception order of connection permission signals. Specifically, a connection destination terminal whose reception order is earlier is designated as a transmission destination terminal, and a connection destination terminal whose reception order is later is designated as a transmission source terminal. Therefore, when a connection permission signal from the communication terminal 4 among the communication terminals 4 to 6 is received earliest, the terminal is designated as a transmission destination terminal, and hence, in the terminal designation list 51 (see FIG. 4), nothing (or communication terminal 4) is registered in the transmission destination terminal address field 51A, and the SIP addresses of the communication terminals 5 and 6 are registered in the transmission source terminal address field 51B.

That is, a connection destination terminal which transmits a connection permission signal to the multipoint connection start terminal is already known, and thus, each time a connection permission signal is received, a transmission destination terminal and a transmission source terminal can be designated in a terminal designation list for the connection destination terminal. Therefore, when a connection permission signal has been received from the communication terminal 4, the terminal designation list 51 is created, and the created terminal designation list 51 is transmitted to the communication terminal 4 (S16). Then, until connection permission signals are received from all the connection destination terminals (S17: NO), the processing returns to S12, and the terminal designation lists 52 and 53 are created for the other communication terminals 5 and 6 and transmitted to the communication terminals 5 and 6, respectively. When connection permission signals are received from all the connection destination terminals (S17: YES), the multipoint connection start processing is ended and a connection request reception process may ensue as described with respect to FIG. 10). In such an alternate embodiment, the same advantageous effects as those in the above embodiments can be achieved.

Additionally, by creating and transmitting a terminal designation list to a terminal which has responded with a connection permission signal immediately (e.g., without waiting for all other terminals), the mesh network may be at least partially established between terminals which have responded. Such a configuration allows the network to avoid a situation in which one or more terminals experiencing network or processing problems prevent the mesh network from being established. For example, if the multipoint connection start terminal were to wait for all terminals to respond, the mesh network might not be established until the network or processing problems of the one or more terminals are resolved. Accordingly, the multipoint connection start terminal may be waiting indefinitely to distribute the terminal designation list and establish the mesh network.

According to one or more further aspects, a communication device or apparatus may be configured to operate as either or both of a multipoint connection start terminal and a connection destination terminal. For example, the device may store computer readable instructions (such as software) allowing the device to operate as either including performing the functions of both types of terminals as described herein.

What is claimed is:

1. A method comprising:
transmitting, by a multipoint connection start terminal, a connection request signal to each of a plurality of communication terminals;
receiving, by the multipoint connection start terminal, a connection permission signal from each of the plurality of communication terminals; and
generating a plurality of terminal designation lists for the plurality of communication terminals including generating a terminal designation list for a first communication terminal by designating one or more other communication terminals as at least one of: a transmission source terminal and a transmission destination terminal in the terminal designation list based on an order in which the connection permission signal from each of the plurality of communication terminals was received.

2. The method of claim 1, wherein the plurality of terminal designation lists are generated upon receipt of connection permission signals from all of the plurality of communication terminals.

3. The method of claim 1, wherein each of the plurality of terminal designation lists is generated upon receipt of a connection permission signal from a corresponding communication terminal.

4. The method of claim 1, wherein each of the plurality of terminal designation lists further includes an authentication key for each connection.

5. The method of claim 1, wherein generating the plurality of terminal designation lists includes:
designating the first communication terminal as a transmission source terminal responsible for transmitting a connection request signal for a connection between the first communication terminal and a second communication terminal when a connection permission signal is received from the second communication terminal prior to the first communication terminal, and
designating the second terminal as the transmission source terminal for the connection between the first and second communication terminals when a connection permission signal is received from the first communication terminal prior to the second communication terminal.

6. The method of claim 1, wherein each of the plurality of terminal designation lists is unique to a corresponding communication terminal.

7. A method comprising:
receiving, by a first communication terminal, a terminal designation list from a multipoint connection start terminal, wherein the terminal designation list specifies at least one of: a transmission source terminal from which a connection request signal is to be received by the first communication terminal and a transmission destination terminal to which a connection request signal is to be transmitted by the first communication terminal and wherein transmission source terminals are specified differently than transmission destination terminals in the terminal list;
when the terminal designation list specifies a transmission source terminal:
receiving a connection request signal from a second communication terminal designated as the transmission source terminal, and
transmitting a connection permission signal to the second communication terminal in response to the connection request signal; and
when the terminal designation list specifies a transmission destination terminal:
transmitting a connection request signal to a third communication terminal designated as the transmission destination terminal; and
receiving a connection permission signal from the third communication terminal.

8. The method of claim 7, further comprising:
when the terminal designation list specifies a transmission source terminal, comparing a first authentication key specified in the connection request signal with a second authentication key specified in the terminal designation list for a connection between the first and second communication terminals.

9. The method of claim 8, wherein transmitting the connection permission signal to the second communication terminal is only performed upon determining that the first and second authentication keys match each other.

10. An apparatus comprising:
at least one processor; and
memory operatively coupled to the at least one processor and storing computer readable instructions that, when executed, cause the apparatus to:
operate as one or more of a multipoint connection start terminal and a connection destination terminal in a communication network, wherein when the apparatus operates as a multipoint connection start terminal, the apparatus performs:
transmitting a connection request signal to each of a plurality of communication terminals,
receiving a connection permission signal from each of the plurality of communication terminals, and
generating a plurality of terminal designation lists for the plurality of communication terminals including generating a terminal designation list for a communication terminal by designating one or more other communication terminals as at least one of: a transmission source terminal and a transmission destination terminal in the terminal designation list based on an order in which the connection permission signal from each of the plurality of communication terminals was received; and
when the apparatus operates as a connection destination terminal, the apparatus performs:
receiving a terminal designation list from a multipoint connection start terminal, wherein the terminal designation list specifies at least one of: a transmission source terminal from which a connection request signal is to be received by the apparatus and a transmission destination terminal to which a connection request signal is to be transmitted by the apparatus and wherein transmission source terminals are specified differently than transmission destination terminals in the terminal list;
when the terminal designation list specifies a transmission source terminal:
receiving a connection request signal from a communication terminal designated as the transmission source terminal, and
transmitting a connection permission signal to the transmission source terminal in response to the connection request signal; and
when the terminal designation list specifies a transmission destination terminal:
transmitting a connection request signal to a communication terminal designated as the transmission destination terminal; and
receiving a connection permission signal from the transmission destination terminal.

11. One or more non-transitory computer readable media storing computer readable instructions that, when executed, cause the apparatus to:
operate as one or more of a multipoint connection start terminal and a connection destination terminal in a communication network,
wherein when the apparatus operates as a multipoint connection start terminal, the apparatus performs:
transmitting a connection request signal to each of a plurality of communication terminals,
receiving a connection permission signal from each of the plurality of communication terminals, and
generating a plurality of terminal designation lists for the plurality of communication terminals including generating a terminal designation list for a communication terminal by designating one or more other communication terminals as at least one of: a transmission source terminal and a transmission destination terminal in the terminal designation list based on an order in which the connection permission signal from each of the plurality of communication terminals was received; and
when the apparatus operates as a connection destination terminal, the apparatus performs:
receiving a terminal designation list from a multipoint connection start terminal, wherein the terminal designation list specifies at least one of: a transmission source terminal from which a connection request signal is to be received by the apparatus and a transmission destination terminal to which a connection request signal is to be transmitted by the apparatus and wherein transmission source terminals are specified differently than transmission destination terminals in the terminal list;
when the terminal designation list specifies a transmission source terminal:
receiving a connection request signal from a communication terminal designated as the transmission source terminal, and
transmitting a connection permission signal to the transmission source terminal in response to the connection request signal; and
when the terminal designation list specifies a transmission destination terminal:
transmitting a connection request signal to a communication terminal designated as the transmission destination terminal; and
receiving a connection permission signal from the transmission destination terminal.
